(19) United States
(12) Patent Application Publication
(10) Pub. No.: US 2025/0202707 A1
(43) Pub. Date: Jun. 19, 2025

(54) METHODS AND SYSTEMS FOR APPLYING ZERO KNOWLEDGE PROOF IN PREDICTIVE ANALYTICS

(71) Applicant: State Farm Mutual Automobile Insurance Company, Bloomington, IL (US)

(72) Inventor: Jacob Braun, Oviedo, FL (US)

(21) Appl. No.: 18/940,610

(22) Filed: Nov. 7, 2024

Related U.S. Application Data
(60) Provisional application No. 63/609,697, filed on Dec. 13, 2023.

(51) Int. Cl. H04L 9/32; H04L 9/00

(52) U.S. Cl. CPC H04L 9/3221; H04L 9/50

(57) ABSTRACT

Zero knowledge proof in predictive analytics is applied to automate creation of an insurance production a blockchain. In implementations, a computing system includes a processor and memory storing computer-executable instructions. The computer-executable instructions, when executed by the processor, cause the processor to receive a request for a policy for a user, the request including an identifier associated with the user; generate a smart contract in a blockchain, the smart contract corresponding to the request and defining an execution condition; cause the smart contract to acquire from a data source, using a protocol and based on the identifier, a fact indicative of the execution condition being satisfied. Based on the fact, the computer-executable instructions further cause the processor to execute the smart contract in the blockchain to generate the policy for the user, and add a block associated with the policy to the blockchain.

### RELATED APPLICATIONS

This U.S. Patent Application claims priority to provisional U.S. Patent Application No. 63/609,697, entitled “METHODS AND SYSTEMS FOR APPLYING ZERO KNOWLEDGE PROOF IN PREDICTIVE ANALYTICS,” filed on Dec. 13, 2023, the entirety of which is incorporated herein by reference.

### TECHNICAL FIELD

The present disclosure relates to predictive analytics in insurance products, and more particularly, to applying zero knowledge proof in the predictive analytics to automate creation of an insurance product on a blockchain.

### BACKGROUND

An insurance product is normally tailored based on information associated with an individual policyholder. A life insurance product, for example, may be determined based at least in part on a person's age, gender, health condition, family medical history, occupation, lifestyle, etc. By using a smart contract, generation of the life insurance product can be fully automated on a blockchain system. Although some information is received when the person submits a request for a life insurance quote, other information, such as information about the person's lifestyle, may be hard to obtain. Such information, however, may play an important role in providing an accurate life insurance quote for the person, and thus may impact information stored in a blockchain in association with a smart contract for a corresponding life insurance product.

For example, if a person takes an average number of 10,000 steps a day for four to five days per week on a regular basis, information about the person's average daily step count may indicate that the person is a healthy individual. In another example, information indicating that a person has been enrolling in cardio exercise training sessions on a regular basis may also indicate that the person is in a healthy condition.

Some insurance companies cooperate with wellness service providers to supplement data associated with a person's activity. However, due to privacy and sensitivity, it is uncommon that subscribers' fitness data is shared directly with the insurance company where the blockchain system may be publicly visible.

Car insurance products, as another example, can also be automated on a blockchain system. A car insurance quote may be determined based on data associated with a driver, such as age, gender, driving history, credit score, years of driving experience, location, insurance history, annual mileage, etc. Particularly, the credit score of the driver may need to be verified to generate an insurance quote. The insurance company may not want to be disclosed with the exact credit score of a customer. Rather, the insurance company may only want to know whether the credit score is above a certain threshold to provide an insurance product, such as a smart contract for an insurance policy stored on a blockchain.

Therefore, there is a need to automate the creation of the insurance product on the blockchain system using zero knowledge proof and/or nearly zero knowledge proof in predictively analyzing data.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example environment, in which, methods for applying zero knowledge proof in predictive analytics is implemented, according to the present disclosure.

FIG. 2 illustrates an example scenario of applying zero knowledge proof in predictive analytics, according to the present disclosure.

FIG. 3 illustrates another example scenario of applying zero knowledge proof in predictive analytics, according to the present disclosure.

FIG. 4 illustrates an example diagram of applying zero knowledge proof in predictive analytics, according to the present disclosure.

FIG. 5 illustrate an example process for applying zero knowledge proof in predictive analytics, according to the present disclosure.

FIG. 6 illustrate an example computing device that implements techniques for applying zero knowledge proof in predictive analytics, as described herein.

### DETAILED DESCRIPTION

Techniques for applying zero knowledge proofs in predictive analytics in insurance systems are disclosed herein.

According to a first aspect, a computing system includes a processor and memory storing computer-executable instructions to perform operations for predictive analytics using zero knowledge proofs. The computer-executable instructions, when executed by the processor, cause the processor to receive a request for a policy for a user. The request includes an identifier associated with the user. The computer-executable instructions also cause the processor to generate an automated program such as a smart contract in a first block of a blockchain. The automated program corresponds to the request and defines an execution condition. The computer-executable instructions further cause the processor to cause the automated program to acquire from a data source, using a protocol and based on the identifier, a fact indicative of the execution condition being satisfied. Based on the fact, the computer-executable instructions further cause the processor to execute the automated program in the first block to generate the policy for the user, store the policy in a second block, and attach the second block to the first block of the blockchain.

In implementations, the automated program is configured to be automatically executed in the block upon the execution condition being satisfied.

In implementations, the computer-executable instructions, when executed by the processor, further cause the processor to cause the automated program to call an application program interface (API) of the protocol to obtain from the data source, based on the identifier, data associated with the execution condition. The computer-executable instructions further cause the processor to generate, based on the data and using a cryptographic hash function, the fact indicative of the execution condition being satisfied. The computer-executable instructions further cause the processor to determine, based on the fact indicative of the execution condition being satisfied, an estimated rate associated with the policy.

In implementations, the protocol includes a Decentralize Oracle (DECO) protocol.

In implementations, the execution condition includes an average daily number of steps taken by the user being equal to or greater than a threshold number of steps. In some examples, the threshold number of steps may be set as 10,000 steps.

In implementations, the data source includes a third-party server associated with a fitness service provided to the user, and the policy is associated with a life insurance policy.

In implementations, the computer-executable instructions further cause the processor to receive inputs indicative of adding a second execution condition to the smart contract. The computer-executable instructions also cause the processor to cause the automated program to acquire from a second data source, using the protocol and based on the identifier, a second fact indicative of the second execution condition being satisfied. The computer-executable instructions further cause the processor to update, based on the second fact, the policy by executing the automated program in the first block of blockchain; and update the second block in the blockchain.

In implementations, the computer-executable instructions further cause the processor to update, based on the second approved fact, a monthly premium of the policy.

In implementations, the automated program defines a plurality of execution conditions, that when the plurality of execution conditions are satisfied, cause the automated program to automatically execute in the blockchain to generate the policy. The computer-executable instructions further cause the processor to cause the automated program to acquire from one or more second data sources, using the protocol and based on the identifier, a plurality of facts indicative of the plurality of execution conditions being satisfied.

In implementations, the computer-executable instructions further cause the processor to receive a second request for a second policy for the user. The second request includes the identifier associated with the user. The computer-executable instructions further cause the processor to generate a second automated program executed in a third block of the blockchain. The second automated program defines a second execution condition being that a credit score of the user satisfies a criteria. The computer-executable instructions further cause the processor to cause the second automated program to acquire from a credit bureau, using the protocol and based on the identifier, a second fact indicative of the credit score satisfying the criteria. Based on the second fact, the computer-executable instructions further cause the processor to execute the second automated program in the third block to generate the second policy, store the second policy in a fourth block, and attach the fourth block to the third block in the blockchain.

According to a second aspect, a computer-implemented method includes receiving, by a processor, a request for a policy for a user. The request includes an identifier associated with the user. The computer-implemented method also includes generating, by the processor, an automated program in a first block of a blockchain. The automated program corresponds to the request and defines an execution condition. The computer-implemented method further includes causing, by the processor, the automated program to acquire from a data source, using a protocol and based on the identifier, a fact indicative of the execution condition being satisfied. Based on the fact, the computer-implemented method further includes executing, by the processor and based on the fact, the automated program in the first block to generate the policy for the user, storing, by the processor, the policy in a second block, and attaching, by the processor, the second block to the first block in the blockchain.

In some examples, the smart contract is an example of an automated program that may be performed by a blockchain system. An automated program may, in the context of a blockchain system, automatically self-execute based on predetermined conditions being satisfied. Accordingly, in some examples, all of the operations described herein as being performed with respect to a smart contract may be performed with respect to any other type of an automated program too.

By using the DECO protocol and zero knowledge proof to verify the execution conditions of an automated program, e.g., a smart contract, necessary information to determine the applicant's qualification for an insurance product can be verified with no disclosure of the applicant's sensitive and/or private information. Generation of the insurance product can be fully automated in the blockchain while maintaining high security of the applicant's personal information.

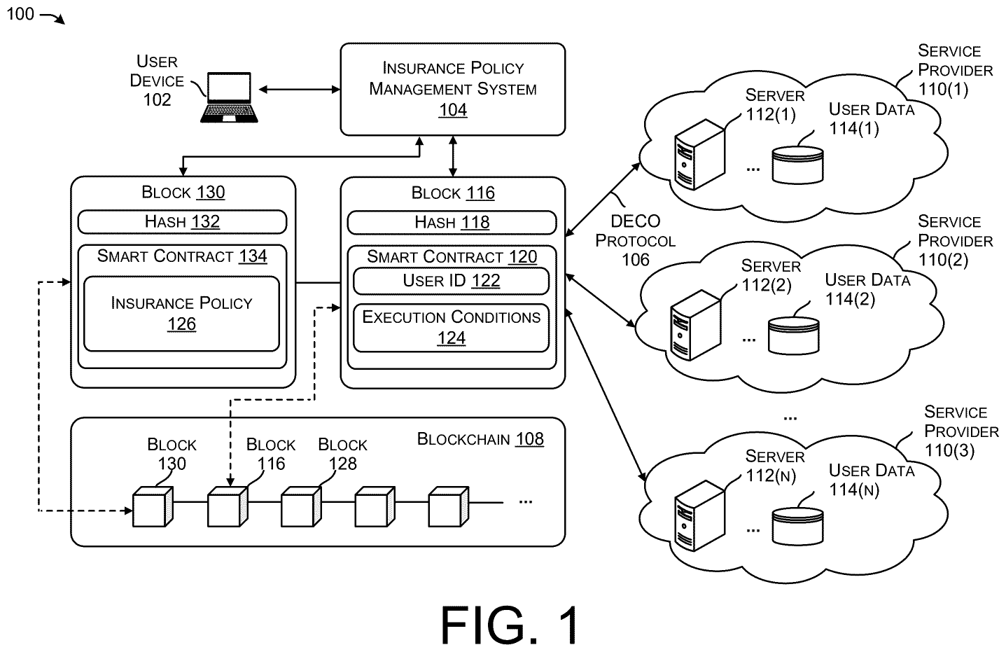

FIG. 1 illustrates an example environment 100, in which methods for applying zero knowledge proofs in predictive analytics are implemented, according to the present disclosure.

As shown in the example environment 100, a user may operate a user device 102 to send a request for an insurance quote to an insurance policy management system 104. The request may include an identification of an applicant or a policy holder, information associated with the applicant's health and lifestyle, other factors may be considered to determine an appropriate policy, etc. Upon receiving the request, the insurance policy management system 104 may create a smart contract 120 configured to automatically execute to generate a life insurance policy 126 for the user when one or more execution conditions 124 are satisfied. The smart contract 120 may be created in a new block (e.g., block 116) and added to a blockchain 108.

In implementations, the smart contract 120 may define one or more execution conditions 124 based on the terms associated with the life insurance policy. Example execution conditions may be related to but not limited to, whether the applicant has heart disease, whether the applicant has diabetes, whether the applicant's blood pressure is in normal range, whether the applicant exercises regularly, conditions associated with the applicant's family medical history, driving record, weight, height, body mass index (BMI) value, and/or other types of conditions. In implementations, the smart contract 120 may generate questions that are answered with either “yes” or “no” corresponding to the one or more execution conditions 124.

The smart contract 120 may send the questions to servers of corresponding service providers, e.g., service provider 110(1), service provider 110(2), . . . , and service provider 110(n) (hereinafter, referred to as service provider 110). For example, a question of “whether the applicant's systolic blood pressure is less than 120 and the applicant's diastolic blood pressure is less than 80” may be sent to a medical record system, e.g., a doctor's clinic or a hospital. As another example, a question of “whether the applicant has more than two reckless driving tickets in the past six months” may be sent to a driving record system. In another example, a question of “whether the applicant walks more than 10 k steps a day” may be sent to a fitness app server associated with an app installed on the applicant's smart phone and/or smart watch.

In implementations, the smart contract 120 may utilize a DECentralized oracle (DECO) protocol 106 to communicate with the servers, e.g., server 112(1), server 112(2), . . . , and server 112(n) (hereinafter referred to server 112), and obtain answers to the questions related to the execution conditions 124. In implementations, the smart contract 120 may call an application program interface (API) of the DECO protocol 106 to establish a transport layer security (TLS) connection with the server 112.

With approval and/or authentication from the user to share information stored in the service provider 110, the smart contract 120 may use a DECO prover (not shown) to query a user data storage of the service provider 110, e.g., user data storage 114(1), user data storage 114(2), . . . , and user data storage 114(n) (hereinafter referred to as user data storage 114) for information related to the user ID 122. The DECO prover may selectively disclose to or hide response information from a DECO verifier (not shown) along with an original proof that the information meets an execution condition represented by the question (e.g., yes or no answer). Once the original proof, also referred to as zero knowledge proof, is verified by the DECO verifier, the original proof (e.g., yes or no answer) may be sent by the DECO verifier to be stored in the block 116. In some examples, the DECO prover may be deployed by the smart contract 120 and the DECO verifier may be deployed on a third-party network. Alternatively or additionally, the DECO prover may be deployed by the insurance policy management system 104.

In some examples, the smart contract 120 may generate multiple questions for an execution condition. For example, an execution condition related to high blood pressure may be mapped to questions like “is the policy holder's systolic pressure below 120?” “is the policy holder's diastolic pressure below 80?” “is the policy holder's systolic pressure below 130?” “is the policy holder's diastolic pressure below 90?” “is the policy holder's systolic pressure below 140?” etc. In some examples, the smart contract 120 may dynamically generate one or more subsequent questions based on the answer received with respect to the first question. For instance, if the answer to “is the policy holder's systolic pressure below 120?” is no, the smart contract 120 may generate a subsequent question “is the policy holder's systolic pressure below 130?” In some examples, the multiple questions for an execution condition may be pre-configured and saved in the storage. The smart contract 120 may select an appropriate subsequent question from the pre-configured multiple questions based on the answer to the first question. In another example, an execution condition related to a health lifestyle may be mapped to questions like “is the policy holder's average daily steps above 5 k?” “is the policy holder's average daily steps above 10 k?” “does the policy holder visit an associated gym at least three times per week?” etc.

In some examples, data related to the lifestyle of the policy holder is constantly collected via one or more applications installed on a smart phone, a smart watch, or any wearable device associated with the policy holder, and may be uploaded to servers 112 of corresponding service providers 110 to be stored as user data 114. Once authorized to access the data related to the lifestyle of the policy holder, the DECO prover may connect to a server of the app and pull all relevant information of the policy holder. The DECO prover may analyze the relevant information and generate a fact as a response to the question. The fact may include an answer encoded using a cryptographic hash function and indicate a proof or non-proof fact on the execution condition. The DECO prover may send the fact and a portion of the relevant information to the DECO verifier. The portion of the relevant information may include minimum information to prove the fact. The DECO prover may discard the rest of the information. The DECO verifier may verify the fact using the minimum information and send the verified fact to the smart contract 120. The DECO verifier may further discard the minimum information.

As discussed herein, by using the DECO protocol, information needed for an insurance policy may be obtained or verified using zero knowledge proof without disclosing any sensitive and/or private information of the policy holder to the insurance company, the insurance agents, the blockchain 108, and/or other elements. For example, although service provider 110(1) may store detailed user data 114(1) about a policy holder's lifestyle, the DECO protocol may allow a binary yes or no answer about the policy holder's lifestyle to be answered based on the detailed user data 114(1), without the detailed user data 114(1) itself being shared or exposed. Accordingly, binary information about the policy holder's lifestyle that may indicate whether the policy holder qualifies for an insurance policy may be obtained and used in association with the smart contract 120, without more detailed information about the policy holder's lifestyle being received or being stored in the smart contract 120 on the blockchain 108 where it may be publicly visible or accessible.

As discussed herein, the smart contract 120 may define multiple execution conditions 124. The execution conditions 124 may be associated with questions that may be answered via the DECO protocol, based on user data 114 stored by one or more service providers 110 as described above. Once all execution conditions 124 are satisfied, the smart contract 120 may automatically execute in block 116 to determine an estimated rate associated with the policy. In implementations, the estimated rate associated with the policy may include a monthly premium, an annual cost, an interest rate, etc. In some examples, the insurance policy management system 104 may generate a new smart contract (e.g., smart contract 134) in a new block (e.g., block 130) to automate the production of the policy based on the execution conditions 124 and the estimated rate. The smart contract 134, once automatically executed, may generate the insurance policy 126 for the user in the block 130. The block 130 may then be attached to the block 116 in the blockchain. The insurance policy 126 may include a contract to be agreed to between a life insurance policy holder and an insurer, where the insurer promises to pay a designated beneficiary a sum of money upon the death of the insurance policy holder. In some examples, the life insurance policy 126 may also define that other events such as terminal illness or critical illness can also trigger a payment. The life insurance policy 126 may additionally define a premium, either to be paid regularly or as one lump sum by the insurance policy holder. In some examples, the life insurance policy 126 may include other expenses, such as funeral expenses. It should be understood that the life insurance product discussed herein is an example of the implementation of the DECO protocol. The present disclosure is not intended to be limiting. The DECO protocol may be used in other types of insurance products, financial products, or any products that would require verification of private and sensitive information of the purchaser.

In implementations, the smart contract 120 may include a block hash 118 that cryptographically reflects the data stored within the block 116, such as the smart contract 120, as well as data stored in a preceding block in the blockchain 128 (e.g., block 128). Each block in the blockchain 108 may store data associated with a corresponding smart contract. As shown in FIG. 1, the block 116 may store data associated with the smart contract 120 including but not limited to an identification of the applicant or the policy holder, execution conditions of the smart contract, a life insurance policy particularly generated for the applicant. The block 128 may store data associated with a different smart contract created for a different user request. The block hash 118 may be cryptographically computed based at least in part on data stored in a proceeding block (e.g., block 128), and therefore, linking the block 116 and the block 128 together. Similarly, the block 130 may include a block hash 132 that cryptographically reflects the data stored within the block 130 such as, the smart contract 134, the insurance policy 126, and the user ID 122 and the execution conditions 124 stored in a preceding block in the blockchain 128 (e.g., block 116). Data stored in the blockchain 108 can be trusted because any changes to a particular block would not be reflected by the block hashes of subsequent blocks in the blockchain 108. Accordingly, once the smart contract is created and added to the blockchain 108, the smart contract can be static and/unmodifiable, such that the smart contract will automatically execute in the corresponding block when the execution conditions are met.

The policy management system 104 may be configured to generate and/or manage a plurality of smart contracts including but not limited to the smart contract 120. The policy management system 104 may be a website, a mobile application, or other type of computer-executable application or system that a user can use via the user device 102. In some examples, the user may be an individual that desires to sign up for a life insurance policy, and to become the policyholder associated with the life insurance policy. In other examples, the user may be an insurance agent or other third party who assists another person with setting up a life insurance policy that will cover the other person as a policyholder.

The user can use the user device 102, such as a personal computer, a smartphone, a tablet computer, a wearable device, or other type of computing device to interact with the policy management system 104. In some examples, some portions of the policy management system 104 may execute on and/or be accessed by the user device 102, while other portions of the policy management system 104 may execute remotely from the user device 102 via one or more servers associated with an insurance company, via computing resources of a cloud computing environment, or via other computing resources. For example, a user interface and/or a virtual user interface of the policy management system 104 may be displayed via the user device 102 to facilitate the user to input information related to an application for an insurance policy. The policy management system 104 may use such information to generate the smart contract, e.g., the smart contract 120, on the blockchain 108. In some examples, the user may input personal information such as age, gender, birthday, Social Security Number (SSN), driver's license number, etc.

In implementations, the policy management system 104 may be configured to validate the information inputted by the user before such information is used to generate the smart contract 120. The policy management system 104 may validate that one or more types of the information match expected formats, data types, and/or value ranges. In some examples, the values of the one or more types of the information may be used to determine whether the user qualifies for a life insurance policy. For example, an insurance company may indicate that a type of life insurance policy is only available to policyholders who are at least 55 years old. Accordingly, in this example, the policy management system 104 may use the information provided by a potential policyholder to verify that the potential policyholder is at least 55 years old before the policy management system 104 adds a corresponding smart contract 120 to the blockchain 108.

As discussed herein, the policy management system 104 may also use DECO protocol to obtain zero knowledge proofs on the information inputted by the user to determine whether the user qualifies for an insurance policy. In some examples, the policy management system 104 may interact with one or more third-party databases or systems to verify information based on zero knowledge proofs.

In general, the more information that an insurance company can gather, the more appropriate insurance product can be built for the potential policy holder. Also, the more accurate the gathered information is, the more appropriate insurance product can be built for the potential policy holder. However, the information may be gathered from various third-party databases using different access credentials and communication protocols. In particular, the amount of the information about a person's lifestyle may be huge as data may be continuously collected using a wearable device in real-time. It is barely possible to retrieve only necessary binary information from such huge amount of data by manually processing and/or relying on a conventional computing device.

The present disclosure applies the DECO protocol and zero knowledge proof in predictive analytics of the gathered information to automate the insurance product generation for a potential policy holder in a blockchain. Only binary information about the potential policy holder's qualification is provided and used in association with a smart contract in the blockchain. All other data including any private and sensitive information of the potential policy holder is not received and not stored in the blockchain, where it may be publicly visible or accessible. Therefore, implementing the DECO protocol and zero knowledge proof in automated of the insurance product generation can greatly improve the data security in the insurance product generation process.

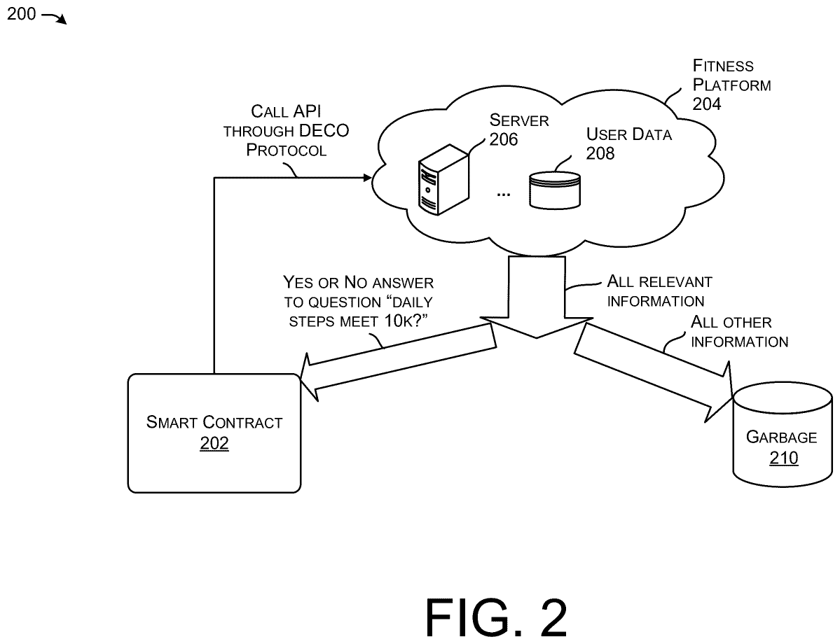

FIG. 2 illustrates an example scenario of applying zero knowledge proof in predictive analytics, according to the present disclosure. The example scenario 200 shows an application of using DECO protocol and the zero knowledge proof to check health activity of a policy holder, who is applying for a life insurance policy.

As illustrated in the example scenario 200, a smart contract 202 corresponding to the policy holder's application may call an application program interface (API) through the DECO protocol, causing the smart contract 202 to connect to a server 206 of a fitness platform 204 through a secure transport layer security (TLS) session. In implementations, the secure TLS session is established between a computing device interacting with the smart contract 202 and the server 206 through Internet. Data transmitted through the secure TLS session may be encrypted using any ciphers and/or hash functions agreed between the computing device and the server 206 during handshaking stage. In some examples, the server 206 may provide to the computing device identification in a form of a digital certificate, which includes a public encryption key of the server 206. Based on the digital certificate, the computing device may generate a unique session key for subsequent encryption and decryption of the data transmitted during the session.

In implementations, the API call through DECO protocol may be triggered by an action of visiting a website of the fitness platform from the computing device. For example, the smart contract 202 may be programmed to include a website address of the fitness platform 204. When verifying an execution condition related to the health activity of the policy holder, the smart contract 202 may generate a question of “daily steps meet 10 k?” and send the question along with an identification of the policy holder to the server 206 through the TLS session. The server 206 may query the user data storage 208 to pull the user data using the identification of the policy holder.

In some examples, the DECO prover deployed by the smart contract 202 or an insurance policy management system (e.g., the insurance policy management system 104 in FIG. 1) may generate an initial answer or an initial fact, with respect to the question based on the pulled user data of the policy holder. The initial answer or the initial fact with respect to the question may be further verified by a DECO verifier using minimum information of the policy holder. Once verified, only the answer or the fact with respect to the question (e.g., yes or no answer to the question “daily steps meet 10 k?”) may be sent to the smart contract 202. All other information pulled from the user data storage 208 may be deleted and sent to a garbage 210.

In some examples, additional execution conditions may be generated in the smart contract, causing the smart contract to obtain proof from a third-party resource. If the additional execution conditions are satisfied, the smart contract may automatically re-execute to update the insurance policy. The block storing the smart contract and the corresponding insurance policy may be updated in the blockchain. For instance, if the policy holder's health condition changes, during the policy renewal process, the smart contract may execute to update the insurance policy, reflecting an updated monthly premium of the insurance policy. In some examples, the insurance management system 104 may generate a new smart contract based on the changed health condition for the policy holder. A new block that stores the new smart contract and the corresponding insurance policy may be attached to the block that stores the previous smart contract and the previous insurance policy.

It should be understood that the example shown in the example scenario 200 is for the illustrative purposes. The present disclosure is not intended to be limiting. The smart contract may use more than one question to determine whether an execution condition is met. In some examples, the policy holder may demonstrate health activities other than daily walking such as, exercising in the gym, swimming, cycling, playing tennis, playing basketball, playing soccer, playing ice hockey, using personal trainers for weight training, attending group cardio classes, etc. The smart contract may generate different type of questions corresponding to the information provided by the policy holder. The smart contract may then verify the execution condition related to health activity by sending the questions to different third-party servers. For example, questions about gym usage may be sent to the gym management system, questions about swimming frequency and distance may be sent to Garmin server, questions about cycling record may be sent to Mormyrid app server, etc. Based on the answers/facts returned by the third-party servers, the smart contract may determine whether the execution condition related to the heath activity is satisfied.

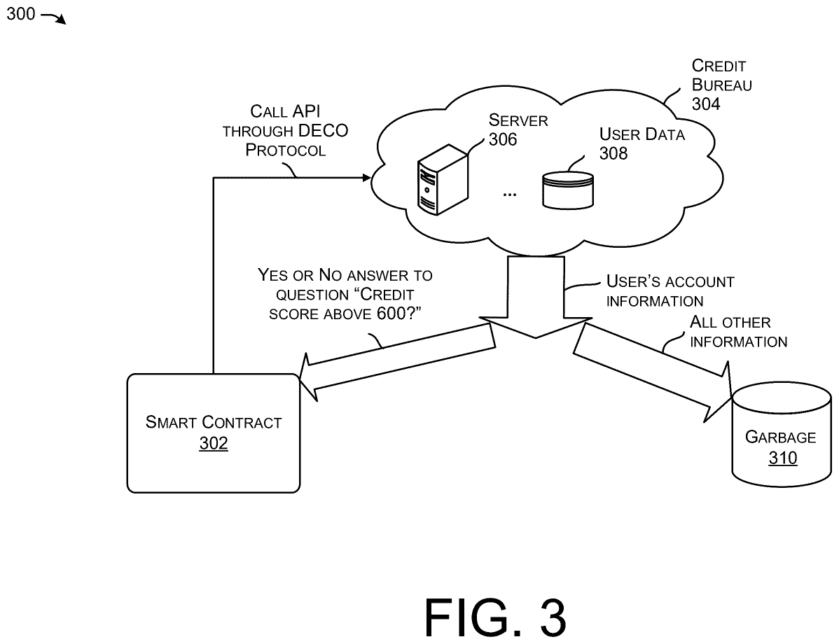

FIG. 3 illustrates another example scenario of applying zero knowledge proof in predictive analytics, according to the present disclosure. The example scenario 300 shows an application of using DECO protocol and the zero knowledge proof to check a credit score of a policy holder, who is applying for a life insurance policy and/or other insurance product.

As illustrated in the example scenario 300, a smart contract 302 corresponding to the policy holder's application may call an application program interface (API) through the DECO protocol, causing the smart contract 302 to connect to a server 306 on a credit bureau network 304 through a secure transport layer security (TLS) session. The credit bureau network 304 may include any credit bureaus that provide credit scores, credit reports, and/or credit checks for the users such as Equifax, Experian TransUnion, etc. In some examples, the credit bureau network 304 may include any credit card companies that the policy holder has an account with. Similar to the example scenario 200, user credit information transmitted through the secure TLS session may be encrypted using any ciphers and/or hash functions agreed between the computing device and the server 306 during handshaking stage. A unique session key may be used for subsequent encryption and decryption of the data transmitted during the TLS session.

In implementations, the smart contract 302 may be programmed to include a website address of the server 306 on the credit bureau network 304. When verifying an execution condition related to the credit score of the policy holder, the smart contract 202 may generate a question of “credit score above 600?” and send the question along with an identification of the policy holder to the server 306 through the TLS session. The server 306 may query the user data storage 308 to pull the user credit score using the identification of the policy holder. In implementations, the identification to pull the credit score may include the name of the policy holder, the birthday of the policy holder, and the social security number (SSN) of the policy holder.

In some examples, the DECO prover deployed by the smart contract 302 or an insurance policy management system (e.g., the insurance policy management system 104 in FIG. 1) may generate an initial answer or an initial fact, with respect to the question based on the pulled credit score of the policy holder. The initial fact may include an answer encoded using a cryptographic hash function and indicate a proof or non-proof fact on the execution condition. The initial answer or the initial fact with respect to the question may be further verified by a DECO verifier using minimum information of the policy holder. Once verified, only the answer or the fact with respect to the question (e.g., yes or no answer to the question “credit score above 600?”) may be sent to the smart contract 302. All other information pulled from the user data storage 308 may be deleted and sent to a garbage 310.

In some examples, the execution condition related to the policy holder's credit score may be verified using more than one question. For instance, an additional question of “credit score above 550?” may be checked if the answer to the question “credit score above 600?” is no. In implementations, same questions to check the credit score of the policy holder may be sent to additional credit bureaus and/or credit card companies other than the credit bureau network 304.

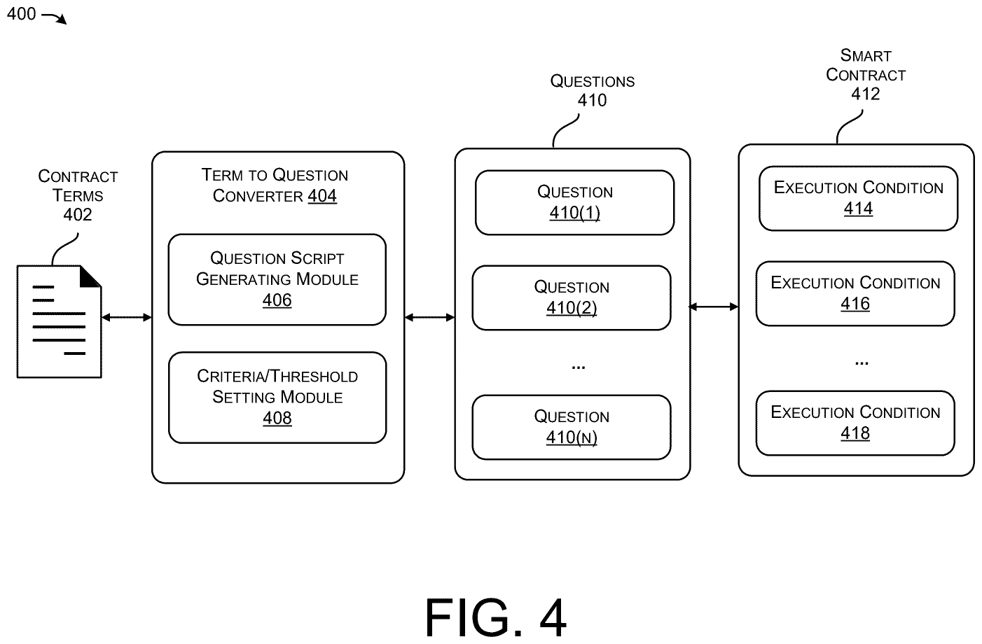

FIG. 4 illustrates an example diagram of applying zero knowledge proof in predictive analytics, according to the present disclosure. The example scenario 400 shows a process of converting the contract terms to execution conditions on the smart contract.

Any insurance product may include a plurality of contract terms to be agreed between the applicant or the policy holder and the insurance product provider (e.g., insurance company). As illustrated, automated of generating an insurance product in a blockchains involves building a smart contract 412 in the blockchain (e.g., blockchain 108 in FIG. 1) and defining execution conditions (e.g., execution condition 414, execution condition 416, . . . execution condition 418), which when met, cause the smart contract 412 to automatically execute to generate the insurance product in the blockchain. Contract terms 402, may be converted to questions (e.g., question 410(1), question 410(2), . . . , question 410(n), hereinafter, referred to as questions 410) to be answered with yes or no. The questions 410 can be programmed in the smart contract 412 as the execution conditions.

In some examples, a term to question converter 404 may be implemented to convert the contract terms 402 to various questions. The term to question converter 404 may include a question script generation module 406 and a criteria/threshold setting module 408. The question script generation module 406 may be configured to generate the word script that describes the type of an execution condition based on the description of the term. For instance, based on a term that describes the applicant maintains a healthy activity, the question script generation module 406 may generate one or more scripts such as, frequency of using an associated gym, daily walking steps, swimming frequency and distance, cycling frequency and distance, etc. The criteria/threshold setting module 408 may set the criterion and/or threshold for each of the scripts. For instance, the criteria/threshold setting module 408 may set the frequency of using an associated gym as at least three times a week. In another example, the criteria/threshold setting module 408 may set the daily walking steps as 10 k per day. In some examples, the criteria/threshold setting module 408 may set multiple criteria and/or thresholds for a question script. For instance, a question script related to blood pressure may be associated with multiple blood pressure thresholds.

Based on the question script and the criteria/threshold, a question to verify an execution condition may be constructed. As discussed herein, the question can be further programmed as part of the smart contract 412.

As discussed herein, the insurance products may vary. The process of converting the contract terms to execution conditions on the smart contract, as shown in FIG. 4, may be applied to any insurance products including but not limited to, life insurance product, auto insurance product, home insurance product, etc. The term to question converter 404 can also be used to convert the terms defined in those insurance products to the appropriate questions for zero knowledge proof. For instance, an auto insurance product may need to verify the applicant's driver's license, criminal history, address, vehicle identification number (VIN), etc. The term to question converter 404 may itemize the information on the applicant's driver's license and generate questions corresponding to the itemized information. In another example, a home insurance product may need to verify the home statistics such as age and lot size, zoning information, roof age, solar panel usage, etc. The term to question converter 404 may construct the questions with respect to these features based on the classification and/or categories defined by the local county. In implementations, the term to question converter 404 may be periodically updated with newly used terms and the corresponding questions.

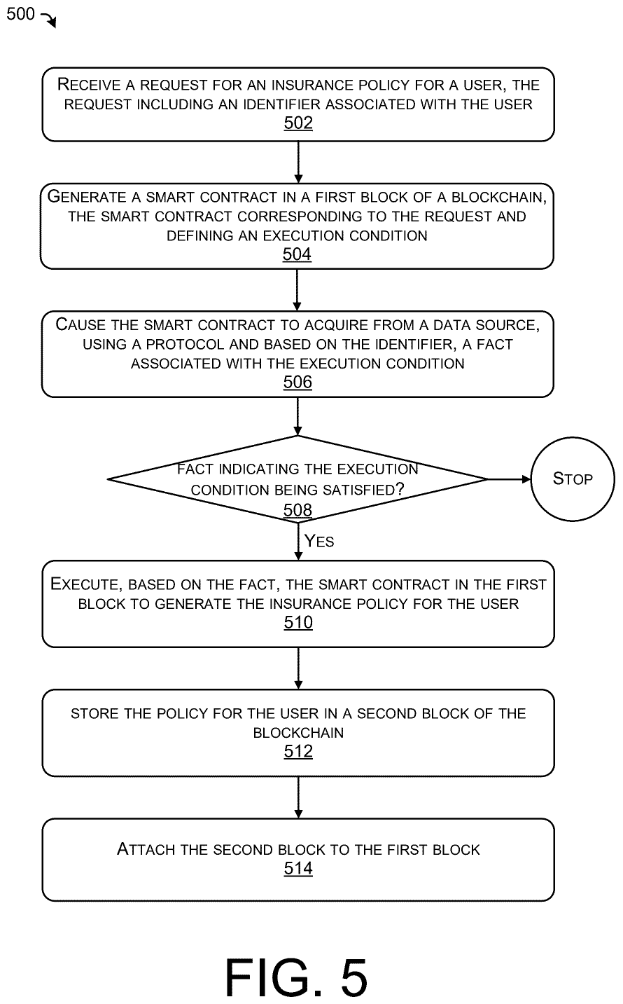

FIG. 5 illustrate an example process for applying zero knowledge proof in predictive analytics, according to the present disclosure. Example process 500 may be implemented by an insurance policy management system (e.g., the insurance policy management system 104, as shown in FIG. 1).

At operation 502, the process may include receiving a request for an insurance policy for a user, the request including an identifier associated with the user. In some examples, the request may be inputted by an applicant from a computing device. The applicant may fill out the information of an online insurance application through a user interface of the computing device. The applicant may provide the identification information such as name, phone number, age, gender, address, social security number, birthday, etc. The applicant may additionally provide information related to his/her health condition, medical history, health activity, or authorization to obtain such information from the third-party networks. In additional, the applicant provided information may also indicate which service providers or third-party resources have the corresponding data. In implementations, the computing device may be the applicant's personal device or a computing device of an insurance agent.

At operation 504, the process may include generating a smart contract in a first block in a blockchain, the smart contract corresponding to the request and defining an execution condition. In implementations, the smart contract (e.g., the smart contract 120 in FIG. 1) may be a computer-readable program that is self-executed in the blockchain when the execution conditions are met. The smart contract includes the information provided by an applicant and defines a plurality of execution conditions. In some examples, the plurality of execution conditions may be verified using a DECO protocol through a third-party resource. The execution conditions may correspond to one or more questions that only need to be answered with yes or no.

At operation 506, the process may include causing the smart contract to acquire from a data source, using a protocol and based on the identifier, a fact associated with the execution condition. The data source may be any third-party source that the applicant is associated with and can provide proofs or facts on the execution conditions. In implementations, the smart contract may call an API of the DECO protocol to communicate with the data source through a secure transport layer security (TLS) session. The smart contract may use a DECO prover deployed thereon to pull the data associated with the execution condition from the data source using the identifier of the applicant. As discussed herein, to verify the execution condition, the smart contract may send the corresponding question to the data source. The DECO prover may generate an initial proof or fact related to the corresponding question. The initial proof or fact may be sent to a DECO verifier along with a portion of the pulled data (e.g., minimum information to verify the proof or fact). The DECO verifier may only send the verified proof or fact to the smart contract. The rest of the pulled data may be discarded by the DECO prover and the DECO verifier.

At operation 508, the process may include determining whether the fact indicates the execution condition being satisfied. As discussed herein, the proof or the fact may indicate a yes or a no answer to the question corresponding to an execution condition. If the fact indicates the execution condition being not satisfied, the process stops. Alternatively, in some instances, the process may include modifying the execution condition and generate new questions to be verified by the data source.

If the fact indicates the execution condition being satisfied, at operation 510, the process may include executing, based on the fact, the smart contract in the first block to generate the insurance policy for the user. In some examples, when all the execution conditions are met, the smart contract automatically execute in the first block to generate an estimated rate associated with the insurance policy. The estimated rate and the fact that the execution condition being satisfied may further be relied on to generate the insurance policy for the applicant.

At operation 512, the process may store the policy for the user in a second block of the blockchain. In implementations, the insurance policy management system may generate a new smart contract to store the policy for the user in the second block.

At operation 514, the process may attach the second block to the first block. In some examples, the second block associated with the insurance policy may include a hash value cryptographically reflects the data stored within the first block as well as data stored in a preceding block in the blockchain. As such, the newly generated block can be linked to the preceding block in the blockchain using the hash value.

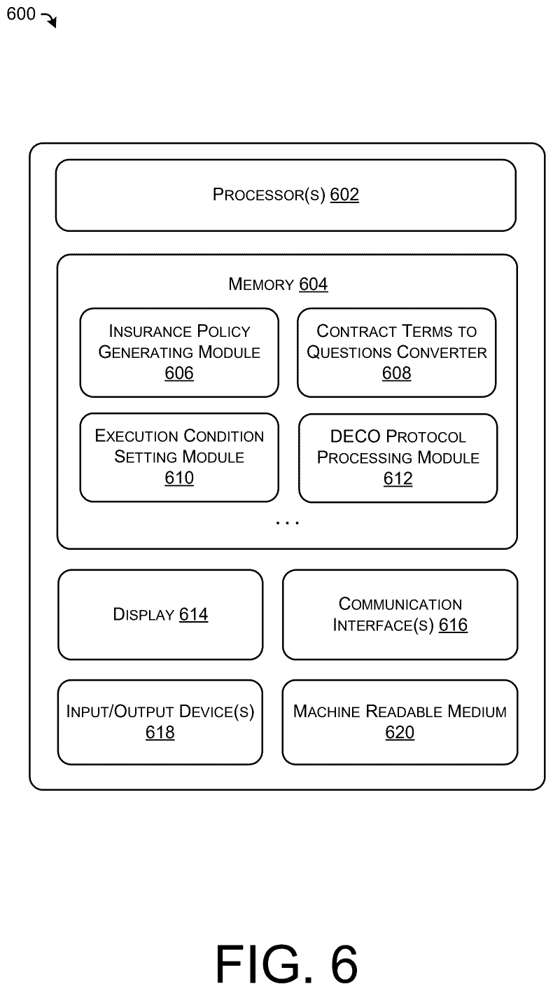

FIG. 6 illustrate an example computing device that implements techniques for applying zero knowledge proof in predictive analytics, as described herein. The example computing device 600 may be implemented on an insurance policy management system that generates smart contracts in the blockchain (e.g., the insurance policy management system 104 in FIG. 1).

As illustrated in FIG. 6, the computing device 600 may comprise processor(s) 602, a memory 604 storing an insurance policy generating module 606, a contract terms to questions converter 608, an execution condition setting module 610, and a DECO protocol processing module 612, a display 614, a communication interface(s) 616, input/output device(s) 618, and a machine readable medium 620.

In various examples, the processor(s) 602 can be a central processing unit (CPU), a graphics processing unit (GPU), or both CPU and GPU, or any other type of processing unit. Each of the one or more processor(s) 602 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 602 may also be responsible for executing all computer applications stored in memory 604, which can be associated with common types of volatile (RAM) and/or nonvolatile (ROM) memory.

In various examples, the memory 604 can include system memory, which may be volatile (such as RAM), non-volatile (such as ROM, flash memory, etc.) or some combination of the two. The memory 604 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 600. Any such non-transitory computer-readable media may be part of the computing device 600.

The insurance policy generating module 606 may be configured to generate an insurance policy that is suitable for an applicant or a potential policy holder based on the information provided by the applicant or the potential policy holder. The insurance policy may include various terms that determine the qualification of the applicant or the potential policy holder for the insurance policy.

The contract terms to questions converter 608 may be configured to convert the various terms to questions that can be answered with only yes or no. Answers to the questions may be provided by third-party resources that the applicant or the potential policy holder is associated with, e.g., medical record systems, fitness app platforms, credit bureaus, credit card systems, etc.

The execution condition setting module 610 may be configured to set the execution conditions based on the questions converted from the contract terms. The execution condition setting module 610 may set various criteria and/or thresholds for an execution condition.

The DECO protocol processing module 612 may be configured to establish a secure transport layer security (TLS) connection between the smart contract and the third-party resource. Additionally, the DECO protocol processing module 612 may be configured to establish the TLD communication session between the smart contract, the third-party resource, and a DECO verifier deployed on a third-party network.

The communication interface(s) 616 can include transceivers, modems, network interfaces, antennas, and/or other components that can transmit and/or receive data over networks or other connections. For example, the communication interface(s) 616 can be used to exchange data between the insurance policy management system 104 and the smart contract 120, any third-party network elements (e.g., the service provider 110), the user devices, and nodes that host the blockchain 108.

Display 614 can be a liquid crystal display or any other type of display commonly used in the computing device 600. For example, display 614 may be a touch-sensitive display screen and can then also act as an input device or keypad, such as for providing a soft-key keyboard, navigation buttons, or any other type of input. Input/output device(s) 618 can include any sort of output devices known in the art, such as display 614, speakers, a vibrating mechanism, and/or a tactile feedback mechanism. Input/output device(s) 618 can also include ports for one or more peripheral devices, such as headphones, peripheral speakers, and/or a peripheral display. Input/output device(s) 618 can include any sort of input devices known in the art. For example, input/output device(s) 618 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 620 can store one or more sets of instructions, such as software or firmware, which embodies any one or more of the methodologies or functions described herein. The instructions can also reside, completely or at least partially, within the memory 604, processor(s) 602, and/or communication interface(s) 616 during execution thereof by the computing device 600. The memory 604 and the processor(s) 602 also can constitute machine readable medium 620.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, are not limited to the forms of memory that are specifically described.

### CONCLUSION

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A computing system for applying zero knowledge proof in predictive analytics, the computing system comprising:
a processor;
memory storing computer-executable instructions that, when executed by the processor, cause the processor to:
receive a request for a policy for a user, the request including an identifier associated with the user;
generate an automated program in a first block of a blockchain, the automated program corresponding to the request and defining an execution condition;
cause the automated program to acquire from a data source, using a protocol and based on the identifier, a fact indicative of the execution condition being satisfied;
execute, based on the fact, the automated program in the first block to generate the policy for the user;
store the policy for the user in a second block of the blockchain; and
attach the second block to the first block.

2. The computing system of claim 1, wherein the automated program is configured to be automatically executed in the first block upon the execution condition being satisfied.

3. The computing system of claim 2, wherein the computer-executable instructions that, when executed by the processor, further cause the processor to:
cause the automated program to call an application program interface (API) of the protocol to:
obtain from the data source, based on the identifier, data associated with the execution condition, and
generate, based on the data and using a cryptographic hash function, the fact indicative of the execution condition being satisfied; and
determine, based on the fact indicative of the execution condition being satisfied, an estimated rate associated with the policy.

4. The computing system of claim 1, wherein the protocol includes a Decentralize Oracle (DECO) protocol.

5. The computing system of claim 1, wherein the execution condition includes an average daily number of steps taken by the user being equal to or greater than a threshold number of steps.

6. The computing system of claim 1, wherein:
the data source includes a third-party server associated with a fitness service provided to the user, and
the policy is associated with a life insurance policy.

7. The computing system of claim 1, wherein the computer-executable instructions that, when executed by the processor, further cause the processor to:
receive inputs indicative of adding a second execution condition to the smart contract;
cause the automated program to acquire from a second data source, using the protocol and based on the identifier, a second fact indicative of the second execution condition being satisfied;
update, based on the second fact, the policy by executing the automated program in the first block; and
update the second block associated with the policy in the blockchain.

8. The computing system of claim 7, wherein the computer-executable instructions that, when executed by the processor, further cause the processor to:
update, based on the second fact, a monthly premium of the policy.

9. The computing system of claim 1, wherein the automated program defines a plurality of execution conditions, that when the plurality of execution conditions are satisfied, cause the automated program to automatically execute in the blockchain to generate the policy, and wherein the computer-executable instructions that, when executed by the processor, further cause the processor to:
cause the smart contract to acquire from one or more second data sources, using the protocol and based on the identifier, a plurality of facts indicative of the plurality of execution conditions being satisfied.

10. The computing system of claim 1, wherein the computer-executable instructions that, when executed by the processor, further cause the processor to:
receive a second request for a second policy for the user, the second request including the identifier associated with the user;
generate a second automated program executed in a third block of the blockchain, the second automated program defining a second execution condition being that a credit score of the user satisfies a criteria;
cause the second automated program to acquire from a credit bureau, using the protocol and based on the identifier, a second fact indicative of the credit score satisfying the criteria;
execute, based on the second fact, the second automated program in the third block to generate the second policy;
store the second policy in a fourth block of the blockchain; and
attach the fourth block to the third block in the blockchain.

11. A computer-implemented method for applying zero knowledge proof in predictive analytics, comprising:
receiving, by a processor, a request for a policy for a user, the request including an identifier associated with the user;
generating, by the processor, an automated program in a first block of a blockchain, the automated program corresponding to the request and defining an execution condition;
causing, by the processor, the automated program to acquire from a data source, using a protocol and based on the identifier, a fact indicative of the execution condition being satisfied;
executing, by the processor and based on the fact, the automated program in the first block to generate the policy for the user;
storing, by the processor, the policy for the user in a second block of the blockchain; and
attaching, by the processor, the second block to the first block.

12. The computer-implemented method of claim 11, wherein the automated program is configured to be automatically executed in the first block upon the execution condition being satisfied.

13. The computer-implemented method of claim 12, further comprising:
causing, by the processor, the automated program to call an application program interface (API) of the protocol to:
obtain from the data source, based on the identifier, data associated with the execution condition,
generate, based on the data and using a cryptographic hash function, the fact indicative of the execution condition being satisfied; and
determine, based on the fact indicative of the execution condition being satisfied, an estimated rate associated with the policy.

14. The computer-implemented method of claim 11, wherein the protocol includes a DECentralized Oracle (DECO) protocol.

15. The computer-implemented method of claim 11, wherein the execution condition includes an average daily number of steps taken by the user being equal to or greater than a threshold number of steps.

16. The computer-implemented method of claim 11, wherein:
the data source includes a third-party server associated with a fitness service provided to the user, and
the policy is associated with a life insurance policy.

17. The computer-implemented method of claim 11, further comprising:
receiving, by the processor, inputs indicative of adding a second execution condition to the smart contract;
causing, by the processor, the automated program to acquire from a second data source, using the protocol and based on the identifier, a second fact indicative of the second execution condition being satisfied;
updating, by the processor and based on the second fact, the policy by executing the automated program in the first block; and
updating, by the processor, the second block associated with the policy in the blockchain.

18. The computer-implemented method of claim 17, further comprising:
updating, by the processor and based on the second fact, a monthly premium of the policy.

19. The computer-implemented method of claim 11, wherein the automated program defines a plurality of execution conditions, that when the plurality of execution conditions are satisfied, cause the automated program to automatically execute in the blockchain to generate the policy, and the computer-implemented method further comprises:
causing, by the processor, the automated program to acquire from one or more second data sources, using the protocol and based on the identifier, a plurality of facts indicative of the plurality of execution conditions being satisfied.

20. The computer-implemented method of claim 11, further comprising:
receiving, by the processor, a second request for a second policy for the user, the second request including the identifier associated with the user;
generating, by the processor, a second automated program executed in a third block of the blockchain, the second automated program defining a second execution condition being that a credit score of the user satisfies a criteria;
causing, by the processor, the second automated program to acquire from a credit bureau, using the protocol and based on the identifier, a second fact indicative of the credit score satisfying the criteria;
executing, by the processor and based on the second fact, the second automated program in the third block to generate the second policy;
storing, by the processor, the second policy in a fourth block of the blockchain; and
attaching, by the processor, the fourth block to the third block in the blockchain.
